(19) United States
(12) Patent Application Publication
(10) Pub. No.: US 2024/0339017 A1
(43) Pub. Date: Oct. 10, 2024

(54) SMART RJ45 LED ILLUMINATION

(71) Applicant: Ubiquiti Inc., New York, NY (US)

(72) Inventors: Wayne LIN, New York, NY (US); Wiley YANG, New York, NY (US); Ryan CHIEN, New York, NY (US)

(21) Appl. No.: 18/627,271

(22) Filed: Apr. 4, 2024

Related U.S. Application Data
(60) Provisional application No. 63/494,227, filed on Apr. 4, 2023.

(51) Int. Cl. G08B 5/36; G06F 3/0482; G06F 3/0484; H04L 12/10

(52) U.S. Cl. CPC G08B 5/36; G06F 3/0482; G06F 3/0484; H04L 12/10

(57) ABSTRACT

A programmable RJ45 jack is disclosed. In some examples, the RJ45 jack may be configured to emit a user-defined color at the presence of a user-selectable data-link characteristic. In some examples, any number of programmable RJ45 jacks may be included within a device, such as an ethernet switch. A configuration database describing a relationship between data-link characteristics and colors may be downloaded to a device that includes the programmable RJ45 jack.

### CLAIM OF PRIORITY

This application claims priority to U.S. Provisional Patent Application No. 63/494,227, filed Apr. 4, 2023, and titled “SMART RJ45 LED ILLUMINATION,” which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

This disclosure relates generally to networking equipment, and more specifically to RJ45 jacks with programmable LED illumination.

### BACKGROUND

Networking electrical equipment, including, but not limited to, ethernet switches and other computing equipment, may be designed to be installed in a standard equipment rack. The networking equipment typically includes a plurality of RJ45 jacks (sometimes referred to as RJ45 ports or connectors) to enable interconnection with other electrical equipment.

The RJ45 jack is typically used for making electrical connections within a network. Conventional RJ45 jacks are limited in the amount and type of information that is conveyed through the status lights.

There exists a need for RJ45 jacks that include flexible and programmable status light indicators.

### SUMMARY OF THE DISCLOSURE

Described herein are apparatuses, systems, and methods to illuminate or provide a back light within one or more RJ45 jacks. The back light colors may be user configurable, or in some cases may be set by default through factory settings. In general, the back light colors may correspond to any number of ethernet link characteristics associated with a particular RJ45 jack. Any feasible number of ethernet link characteristics may be monitored, therefore any feasible number of back light colors may be visible.

In general, a configuration database may be used to associated different back light colors with different ethernet link characteristics. An ethernet link characteristic may describe a quality or quantity associated with ethernet data passing through any RJ45 jack. In some other examples, an ethernet link characteristic may be related to other devices connected or coupled through the RJ45 jack.

The configuration database may be determined or generated by a user. In some examples, a user may determine some or all of the configuration database through a graphical user interface. The configuration database may be transferred or transmitted into any feasible device that includes RJ45 jacks capable of back light such as, for example, an ethernet switch.

Any of the RJ45 jacks described herein may include a light emitting diode (LED) configured to emit light into a cavity within the RJ45 jack. In general, the LED is a multi-color LED capable of emitting a wide variety of colors and, typically, more than two colors. In some examples, the RJ45 may include no internal light guides, at least one light guide, or at least two light guides. The light guides may direct light from the LED into the cavity of the RJ45 jack. In some implementations, one or more of the light guides may also include grooves to guide contacts within the RJ45 jack.

Although LEDs are described herein, persons skilled in the art will recognize that other light sources may be used. For example, laser diodes, multiple incandescent lamps, organic LEDs, polymer LEDs, and the like.

Any of the methods described herein may be used for indicating ethernet link information through RJ45 jacks of a device. Any of the methods may include receiving a configuration database that assigns colors to different ethernet link characteristics, determining, by the device, ethernet link characteristics associated with at least one ethernet port of the device, and back lighting the at least one ethernet port with a color, wherein the color is determined by the at least one ethernet link characteristic and the configuration database.

In general, the configuration database may determine or describe an association between any feasible ethernet link characteristic and any feasible color. Ethernet link characteristics may include link speed, link power consumption, link throughput, data packet type, association with a virtual local area network (VLAN), or the like. In some examples, ethernet link characteristics may also include attached cable quality, attached cable length, type of device connected to the RJ45 port, up time of the RJ45 port, or the like.

In any of the methods described herein, the configuration database may be provided by a controller separate from the device. In some variations, the configuration database may be provided to the controller by a user. In general, the controller may be internal or external with respect to the device. The controller may be coupled to the device through a network. In some cases, the controller may be implemented on a remote server. In some examples, the controller may be a processor collocated within the device. The configuration database may be uploaded to the controller by a user. In some variations, the configuration database may include a default color assignment stored within the device.

In any of the methods described herein, the ethernet link characteristic may be an amount of power provided by the ethernet port for power-over-ethernet (POE) equipment coupled to the at least one ethernet port. In some examples, the color of the back light can change in response to changing amounts of power provided by the at least one ethernet port.

In any of the methods described herein, the ethernet link characteristic is based, at least in part, by a type of device coupled to the at least one ethernet port. In general, the type of device includes at least one of an ethernet switch, a wired access point, a wireless access point, a server, or an intermediate node. In some examples, the ethernet link characteristic may be based, at least in part, on a data throughput of the at least one ethernet port. In some variations, the data throughput may be at least one of a real-time data throughput or a data throughput over a predetermined period of time.

In any of the methods described herein, the color of the back light may be further determined, at least in part, by a virtual local area network (VLAN) packet type included in ethernet data passing through the at least one ethernet port. In some examples, the color of the back light may be further determined, at least in part, by at least one of cable quality or cable length of cable coupled to the at least one ethernet port. In some other examples, the color of the back light may be further determined, at least in part, by a temperature of the at least one ethernet port. In yet another example, the ethernet link characteristic may be based, at least in part, on a data link speed of the at least one ethernet port.

In any of the methods described herein back lighting the at least one ethernet port may be based, at least in part, on receiving an command to locate the at least one ethernet port. In some aspects, the received command may cause a cavity of the at least one ethernet port to blink or pulsate.

Any of the methods described herein may include a method for generating a configuration database for back lit RJ45 jacks of a device via a graphical user interface. The method may include detecting, via a user interaction with a graphical user interface, a user selection of a first ethernet port from a plurality of ethernet ports of the device, assigning, by the user, a first ethernet link characteristic to the first ethernet port, assigning, by the user, a first color to the first ethernet link characteristic, generating a configuration database based on the assignment of the first color to the first ethernet link characteristic, and transmitting the configuration database to the device.

Any of the methods may also include displaying a simulation of the device based at least in part on the configuration database. In general, the simulation may be displayed on any feasible display including a smart phone, a tablet computer, a laptop computer, or the like. In some variations, the simulation may be shown or rendered through a web browser window. The simulation may include displaying a simulation of the ethernet port based at least on the configuration database.

In any of the methods described herein, the configuration database may determine the back light color of the first ethernet port of the device. Furthermore, any of the methods described herein may include displaying, in response to the user selection of a first ethernet port, a plurality of ethernet link characteristics and selecting, by the user, the first ethernet link characteristic from the plurality of ethernet link characteristics. In general, the graphical user interface may include any number of drop-down menus. In some examples, a plurality of ethernet link characteristics may be displayed with a drop-down menu.

Any of the methods described herein may include displaying an image of the device, wherein detecting the user selection of the first ethernet port is in response to displaying the image of the device. In general, the displayed image of the device may include all parts associated with the device including, but not limited to, ethernet ports (RJ45 jacks).

Any of the methods described herein may include displaying a plurality of colors in response to assigning the first ethernet link characteristic to the first ethernet port and selecting the first color from the plurality of colors. In general, the plurality of colors may be displayed through a drop-down menu.

Any of the methods described herein may include assigning, by the user, a second ethernet link characteristic to the first ethernet port, assigning, by the user, a second color to the second ethernet link characteristic, and generating a configuration database based on the assignment of the second color to the second ethernet link characteristic. In general, any number of ethernet link characteristics may be assigned and monitored with respect to any ethernet port. Thus, some ethernet ports may have one, two, or any number of ethernet link characteristics monitored and associated with any feasible color. In some cases, the color assignments may be uniform within a group of ethernet ports, however, in some other cases, the color assignments may be distinct and different for each ethernet port.

Any of the methods described herein may include detecting, via a user interaction with a graphical user interface, a user selection of a second ethernet port from a plurality of ethernet ports of the device, assigning, by the user, a third ethernet link characteristic to the second ethernet port, assigning, by the user, a third color to the third ethernet link characteristic, and generating a configuration database based on the assignment of the third color to the third ethernet link characteristic. In general, the device may include any feasible number of ethernet ports.

Any RJ45 jack, as disclosed herein, may include a light emitting diode (LED) disposed within the RJ45 jack and a first light guide disposed between the LED and a cavity in the RJ45 jack configured to receive a RJ45 plug, wherein the first light guide is configured to emit light from the LED into the cavity. In general, the RJ45 jack may include any number of cavities that can receive any number of RJ45 plugs. In some examples, an RJ45 jack may be referred to as an ethernet port.

In some examples, the LED of the RJ45 jack may be configured to emit more than two colors. In general, the LED may be configured to emit a semi-continuous spectrum of colors. In some variations, the LED may be a surface mount LED.

In some examples, the first light guide may be configured to guide contacts of the RJ45. In general, any light guides of the RJ45 jack may include one or more grooves that may be used to guide contacts. In some examples, the RJ45 jack may include a second light guide. In general, the RJ45 jack may include any number of light guides. In some cases, the second light guide may be disposed between the first light guide and the LED. In some examples, any light guide may contact and/or surround the LED. In cases when the LED is cubic or cubic-like in shape, any light guide may surround five sides of the LED.

In some examples, the RJ45 jack may include a first light guide that is configured to transmit light from the LED to the second light guide. In some variations, the RJ45 jack may include a printed circuit board. In general, the LED may be a surface mount LED which may be mounted on the printed circuit board. In some examples, the second light guide may contact the printed circuit board. In general, any light guide of the RJ45 jack may contact the printed circuit board.

In any of the RJ45 jacks described herein, the first light guide may include an opening to receive the LED. Thus, the LED may be directly exposed through the first light guide into the cavity. In general, any of the light guides of the RJ45 jack may include an opening to receive the LED. Thus, in any of the RJ45 jacks described herein, at least one surface of the LED may be configured to emit light directly into the cavity.

An RJ45 jacks, as disclosed herein, may include an opening configured to receive an RJ45 plug into a cavity, a first light emitting diode (LED), a second LED, wherein the first LED and the second LED are disposed on opposite sides of the opening, and a third LED configured to emit light into the cavity.

Any of the RJ45 jacks disclosed herein may include a first light guide configured to guide light from the first LED to a surface of the RJ45 jack and a second light guide configured to guide light from the second LED to the surface of the RJ45 jack. In some examples, the surface may coincide with the opening configured to receive the RJ45 plug.

Any of the RJ45 jacks described may further include a third light guide configured to disperse light from the third LED into the cavity. In some embodiments, the diffuser (the third light guide) may more evenly distribute light within the cavity. In some examples, the third light guide may contact at least one surface of the third LED.

In any of the RJ45 jacks described herein, the third LED may be a three color LED configured to emit three or more colors. In any of the RJ45 jacks described herein may further include a printed circuit board configured to mount the first, second, and third LEDs.

Any of the RJ45 jacks described herein may include a conductive shell configured to provide electromagnetic shielding. In some examples, in addition to the conductive shell, the RJ45 jack may include an insulator disposed between the conductive shell and a jack body, wherein the jack body is configured to form the cavity and support electrical contacts of the RJ45 jack. In any of the RJ45 jacks described herein, the insulator may be configured to provide electrostatic discharge protection for the third LED. Furthermore, in some examples the conductive shell may include contacts configured to provide a low-impedance electrical path to a predetermined voltage.

In any of the RJ45 jacks described herein, the first and second LEDs may be multicolor LEDs.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a block diagram of an example network system.

FIG. 2 shows example back lit RJ45 jacks that may be included with any enhanced ethernet switch.

FIGS. 3A-3E show various example arrangements of back lit RJ45 jacks that may be included with any enhanced ethernet switch.

FIGS. 4A-4C are cross-section drawings of an example two-row back lit RJ45 jack.

FIG. 5 is an exploded view of an RJ45 jack.

FIGS. 6A and 6B are cross-section drawings of another example two-row back lit RJ45 jack.

FIG. 7 is an exploded view of an RJ45 jack.

FIG. 8 is cross-section drawing of another example two-row back lit RJ45 jack.

FIG. 9 is an exploded view of an RJ45 jack.

FIGS. 10A-10B are illustrations showing example shells for RJ45 jacks.

FIG. 11 is a flowchart showing an example method for generating color assignment information (e.g., a configuration database) for back lit RJ45 jacks of an ethernet switch.

FIG. 12 shows an example graphical user interface.

FIG. 13 is a flowchart showing an example method for controlling back lit RJ45 jacks.

FIG. 14 shows a block diagram of a device that may be one example of the console or switch of FIG. 1.

FIG. 15A is a cross-section drawing of another example two-row back lit RJ45 jack.

FIG. 15B shows an underside view of the RJ45 jack of FIG. 15A.

FIG. 16A a cross-section drawing of another example two-row back lit RJ45 jack.

FIG. 16B shows an underside view of the RJ45 jack of FIG. 16A.

FIG. 17A a cross-section drawing of another example two-row back lit RJ45 jack.

FIG. 17B shows an underside view of the RJ45 jack of FIG. 17A.

FIG. 18 shows an example user interface that may be used to configure or program LED behaviors for any of the LEDs described herein.

FIG. 19A is another exploded view of an RJ45 jack.

FIG. 19B shows a cross-section view of the RJ45 jack of FIG. 19A.

FIG. 20A is another exploded view of an RJ45 jack.

FIG. 20B shows a cross-section view of the RJ45 jack of FIG. 20A.

FIG. 21A shows a cross section of an RJ45 jack.

FIG. 21B shows a view of the light guide of FIG. 21A.

FIG. 22 shows an example implementation of an RJ45 jack.

### DETAILED DESCRIPTION

The present disclosure is related to systems, methods, computing device readable media, and devices that solve technical problems related to visually indicating ethernet link information that may be associated with one or more configurable or programmable RJ45 jacks. In general, operation of the RJ45 jacks may be user definable. That is, for any feasible RJ45 port, a user may specify a an ethernet link characteristic and a back light color to associate with that ethernet link characteristic. This information may be included within a configuration database. The configuration database may be generated locally or remotely and then downloaded to any feasible device that include RJ45 jacks that have programmable back lights.

Devices that include the programmable RJ45 jacks may advantageously display any feasible information through back light colors. The colors as well as the link characteristics may be determined by a user, thereby allowing the user to fully customize operation of any device that includes configurable or programmable RJ45 jacks.

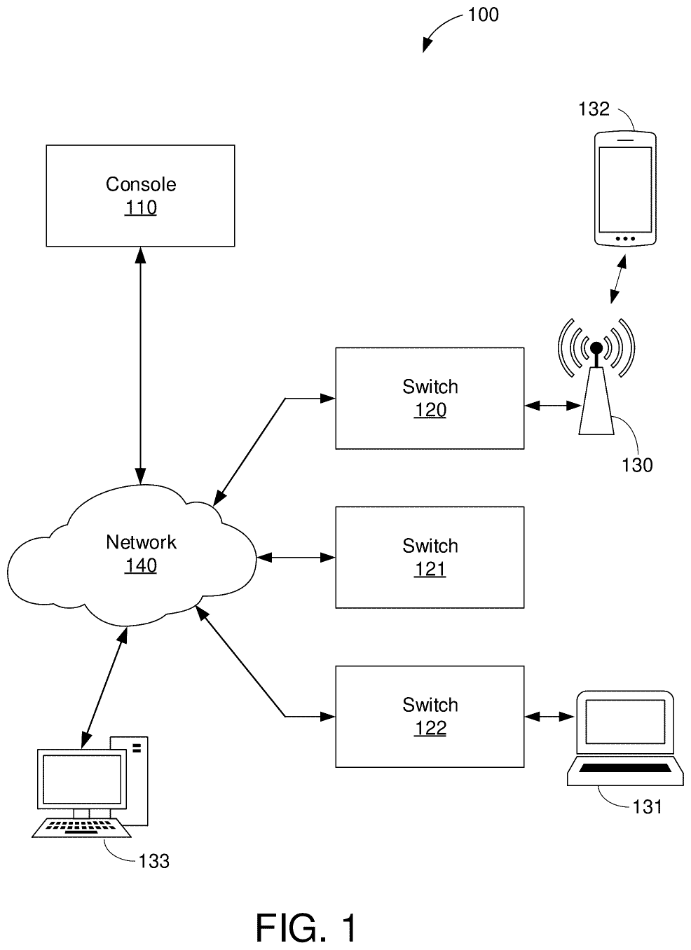

FIG. 1 is a block diagram of an example network system 100. The network system 100 may enable the transfer of data between two or more devices. Example devices may include “endpoint” devices (data sink or data source devices) such as computers, servers, printers, scanners, and the like. Other example devices may include “intermediate” devices (devices that pass-through data and/or route data) such as access points, routers, ethernet switches, and the like. The network system 100 may include a console 110, enhanced ethernet switches 120-122, endpoint devices 130-133, and a network 140. Other example network systems may include additional devices or fewer devices.

The network 140 may be any feasible data (computer) network capable of carrying data. In some examples, the network 140 may be a single, isolated network, or may be a collection of several interconnect networks. The network 140 may be a wired network, a fiber optic network, or a wireless network. In some variations, the network 140 may be a combination of any or all of these types of networks. The network 140 may be a private network, a public network, a local area network, a virtual network, a wide area network, or a combination of these and any other feasible networks. In some examples, the network 140 may include the Internet.

The enhanced ethernet switches 120-122 may be ethernet switches that transmit and receive ethernet data packets. Although only three enhanced ethernet switches 120-122 are shown in FIG. 1, in other implementations, the network system 100 may include any number of enhanced ethernet switches 120-122. In some implementations, the enhanced ethernet switches 120-122 may include a plurality of back lit RJ45 jacks. In contrast to conventional RJ45 jacks found on typical ethernet switches, the color and functionality of the back lit RJ45 jacks found on the enhanced ethernet switches 120-122 may be user configurable. The enhanced ethernet switches 120-122 may transmit and receive data from any number of devices, including the example devices 130-133.

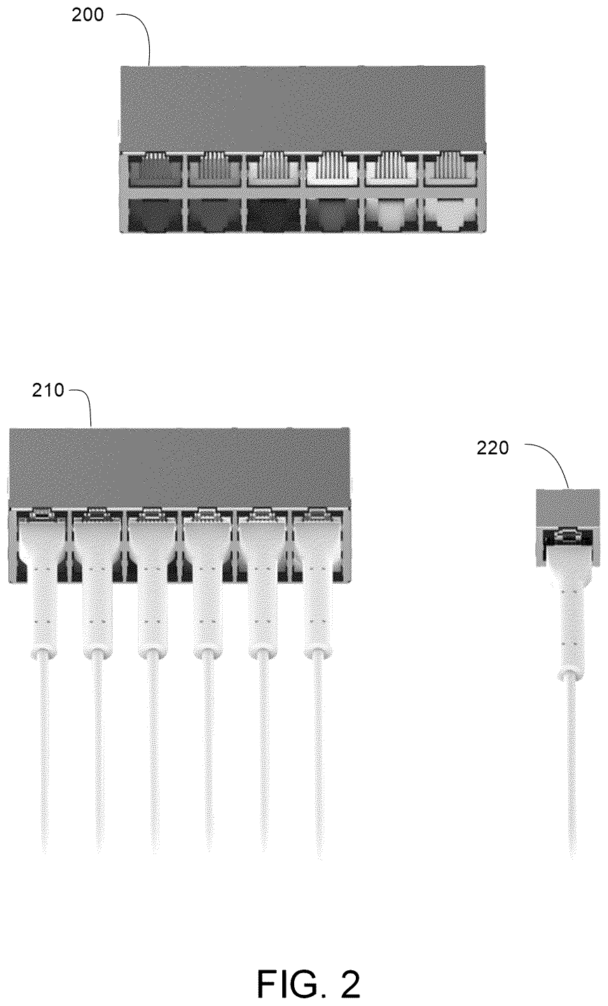

In some examples, the console 110 is used to assign colors and their meaning to any of the RJ45 jacks. Different colors may be used to indicate different communication attributes and/or device characteristics that may be monitored with respect to, or associated with a particular RJ45 jack. The number of available colors may be based on the type or number of light emitting diodes (LEDs) used to provide illumination for the RJ45 jacks. In some variations, light may be emitted from within the RJ45 jack and bathe an inserted RJ45 connector. In some examples, an LED may provide illumination from the RJ45 jack to indicate the presence or absence of power (power-over-ethernet), data throughput speeds, assignment to a particular virtual local area network (VLAN) or the like. Communication attributes and device characteristics that may be shown by the LEDs are described in more detail in conjunction with FIG. 2.

In general, LEDs can refer to any solid state light emitting source such as laser LEDs, organic LEDs, polymer LEDs, and the like. In some cases, the LEDs may be replaced with any feasible light source including two or more incandescent lamps that are arranged to mix multiple light colors. In some examples, different colors may be generated by mixing the light from multiple LEDs. For example, mixing the light from red, green, and blue LEDs may allow the generation of a wide variety of colors. Furthermore, multiple LED colors may be produced by a single discrete LED device that includes (within the discrete LED) multiple LEDs. Although red, green, and blue colors are mentioned here, other LED colors are possible.

The console 110 may be implemented with a physical processing node (not shown) coupled to the network 140. In other variations, the console 110 may be a virtual console implemented in software across one or more compute platform coupled directly or indirectly to the network 140. Access to the console 110 to assign color functionality may be through a web-based portal or a mobile device executing an application (e.g., an app) that, in turn, generates or modifies a configuration database that is uploaded to each enhanced switch 120-122.

The example devices 130-133 include a wireless access point 130, a laptop 131, a mobile device 132, and a computer 133. Although only four devices 130-133 are shown, the network system 100 may include any number of devices. The devices may be endpoint devices such as the laptop 131, the mobile device 132, and the computer 133 or intermediate devices such as the wireless access point 130. The devices 130-133 may be coupled to any of the enhanced switches 120-122 or, in some cases, directly to the network 140.

FIG. 2 shows example back lit RJ45 jacks that may be included with any enhanced ethernet switch. A 2×6 (two rows with six RJ45 jacks per row) RJ45 jack 200 illustrates example colors that may be assigned to different RJ45 jacks. The RJ45 jack 210 is a 2×6 jack with six inserted cables. A single RJ45 jack 220 is shown as well. Notably, in any of the RJ45 jacks 200, 210, and 220, the back light illuminates substantially all of the interior cavity of each individual RJ45 jack. Although described herein with respect to an ethernet switch, persons skilled in the art will recognize that the back lit RJ45 may be deployed on any feasible device including access points, cameras, computers, or any other device using a RJ45 jack. Furthermore, although a 12-port (2×6) ethernet switch is shown here, the back lit RJ45 may be used with any size ethernet switch including, but not limited to, 4-port, 8-port, 24-port, and 32-port ethernet switches.

As described above with respect to FIG. 1, the back lit RJ45 jacks may be configured to indicate different ethernet link information that may be associated with any individual RJ45 jack (sometimes referred to as an RJ45 port). For example, a processor within an enhanced ethernet switch may be configured to monitor ethernet link information (data link metrics and/or connected device characteristics) as listed below:
data link speed (i.e., 10 GbE, GbE, 100 MbE)
PoE power consumption
Ethernet throughput (i.e., real-time throughput)
Ethernet throughput (i.e., over a period of time—for example, 10 gigabytes over the last 24 hours)
Temperature of the port/device
cable quality
cable length
packet type filter (e.g., VLAN)
port connection on both ends (display same LED color on the ends to guide a link)
link up time of the port, etc.
connected device (e.g., another switch one color, an AP another, etc.)

This list is not exhaustive, but rather only a partial list of ethernet or port characteristics or attributes that may be associated with any feasible color. In some variations, different meanings may be tied to blinking, rather than a solid, light. In one example, a back light color may be associated with power supplied with respect to a threshold amount of power consumed by a PoE device. In another example, the back light color may change to different colors as determined by the power consumed by a PoE device. In yet another example, the back light color may be determined by the type of device connected to the RJ45 jack. Different colors may be associated with a computer, laptop, mobile device, wireless access point, server, intermediate node, ethernet switch, and the like.

In some implementations, the back light color may be determined by data throughput associated with an RJ45 jack. For example, if data throughput is greater than a threshold, then the back light color may be set to a first color. If the data throughput is less than the threshold, then the back light color may be set to a second color, different from the first color. In another example, different data throughput rates may be associated with different colors.

In some examples, the back light color of the RJ45 jack may be determined by an assigned VLAN. Different VLANs may be assigned different colors. In another example the back light color may be determined by at least one or a cable quality or cable length coupled to the RJ45 jack.

In some examples, the behavior of the back light may be configurable or controllable. For example, the back light LED of a particular RJ45 jack may be configured to blink or pulsate to enable a user to locate the particular RJ45 jack. In some cases, the user can select or determine a particular color or blinking pattern for the back light LED.

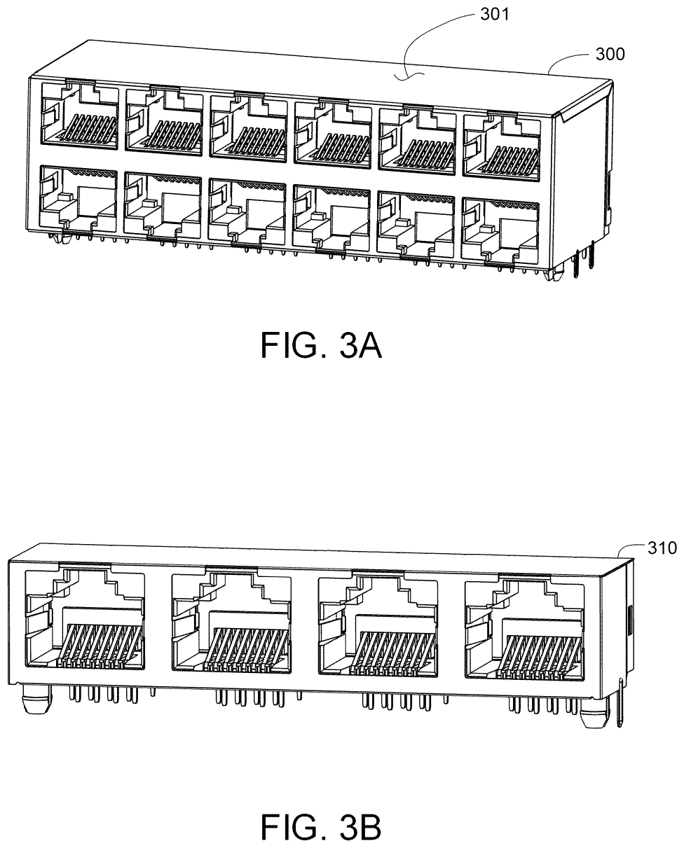

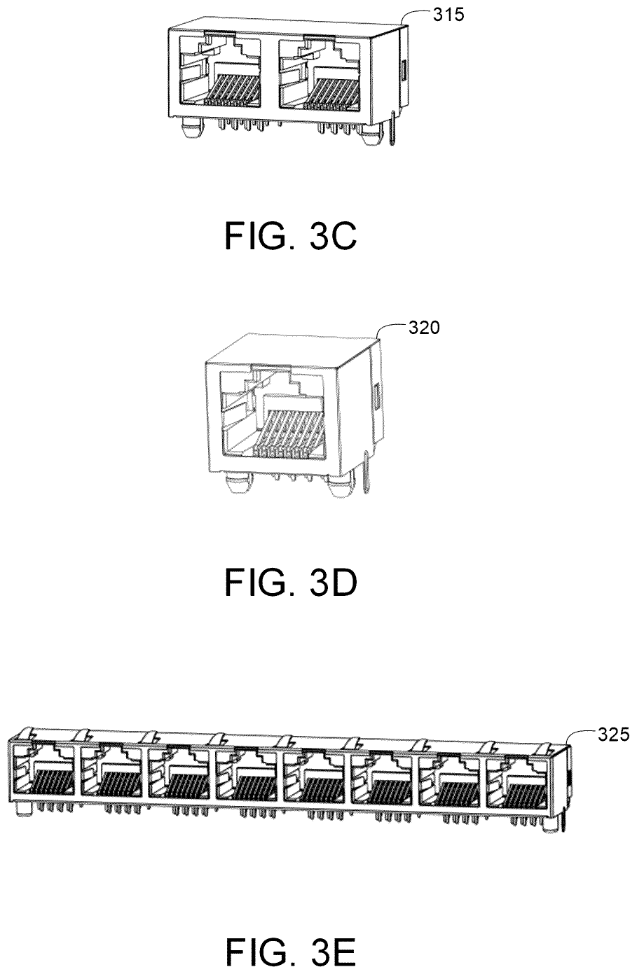

FIGS. 3A-3E show various example arrangements of back lit RJ45 jacks that may be included with any enhanced ethernet switch. FIG. 3A shows RJ45 jack 300 that is a 2×6 configuration similar to the RJ45 jack 200 of FIG. 2. Notably, the RJ45 jack 300 may include a conductive shell 301. The shell 301 may provide electrical shielding from noise as well as help suppress electromagnetic interference (EMI). The shell 301 may include pins that are coupled to an electrical ground.

FIG. 3B shows an RJ45 jack 310 that is a 1×4 (one row with four connectors) arrangement. FIG. 3C shows an RJ45 jack 315 that is a 1×2 arrangement. FIG. 3D shows a single RJ45 jack 320. FIG. 3E shows a 1×8 arrangement of a RJ45 jack 325. Although not explicitly indicated, the RJ45 jacks 310, 315, 320, and 325 may also include a conductive shell similar to the RJ45 jack 300. Other arrangements of RJ45 jacks are possible. For example, any feasible number of rows and columns of RJ45 ports are possible.

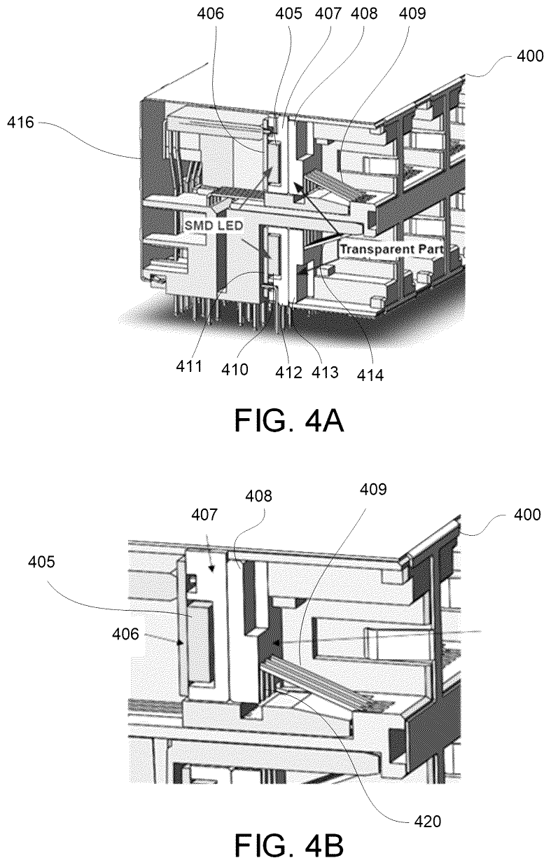

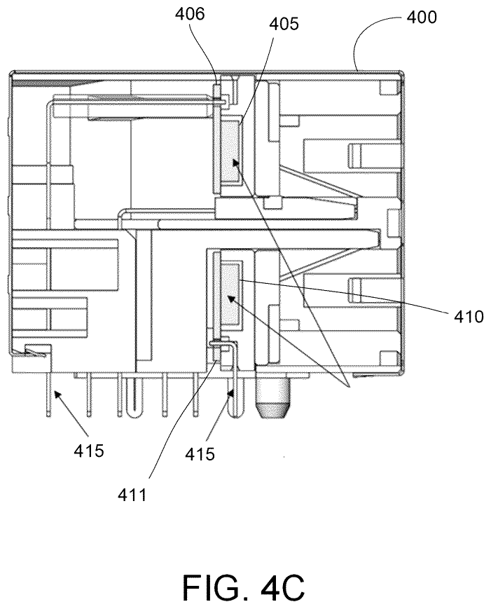

FIGS. 4A-4C are cross-section drawings of an example two-row back lit RJ45 jack 400. FIG. 4A shows the RJ45 jack 400 with a first LED 405 and a second LED 410. Each LED is mounted onto a printed circuit board (PCB). Thus, the first LED 405 is mounted to a first PCB 406 and the second LED 410 is mounted to a second PCB 411. The light from the LEDs are diffused into an inner region or cavity of the RJ45 jack 400, typically into the region including the contacts. The first LED 405 emits light into a first light guide 407 which emits light into a second light guide 408. The first light guide 407 is shaped to substantially surround the first LED 405. For example, the first light guide 407 may surround five sides of the first LED 405. In some cases, the first light guide 407 may contact the first PCB 406. The first light guide 407 may be disposed between the second light guide 408 and the first LED 405. In this way, the first light guide 407 can more efficiently capture light from the first LED 405. The second light guide 408 may be adjacent, and in some cases contact, the first light guide 407. In some implementations, physical contact between the first light guide 407 and the second light guide 408 may enable efficient communication (capture, emission, conduction, diffusion, and the like) of light from the first light guide 407 to the second light guide 408. In a similar manner, the second LED 410 may be surrounded by the third light guide 412 which is adjacent to the fourth light guide 413. That is, the third light guide 412 may surround five sides of the second LED 410. The third light guide 412 may be disposed between the second LED 410 and the second LED 410. The first LED 405 and the second LED 410 may be multicolor LEDs. That is, each LED may emit a variety of colors, not just one or two colors. In some examples, the first LED 405 and the second LED 410 can emit at least three colors (e.g., red, green, blue (RGB) light). In some other examples, the first LED 405 and the second LED 410 can emit at least four colors (e.g., red, green, blue, white (RGBW) light). Although discrete colors are mentioned here, a variety of colors may be generated by the first LED 405 and the second LED 410 by mixing together different amounts of discrete colors.

Notably, the second light guide 408 and the fourth light guide 413 are positioned within (centrally and toward the middle of) the RJ45 jack 400. In some variations, an RJ45 plug (not shown) on an RJ45 cable may be close to, and in some cases touch the second light guide 408 or the fourth light guide 413, particularly when inserted into the RJ45 jack 400. Since typical RJ45 plugs are clear and/or translucent, the RJ45 plugs may function as light pipes to conduct light from the second light guide 408 and/or the fourth light guide 413.

The RJ45 jack 400 includes upper contacts 409 and lower contacts 414. The second light guide 408 may include grooves to guide and position the upper contacts 409 and the fourth light guide 413 may include grooves to guide and position the lower contacts 414. In this manner, the second light guide 408 and the fourth light guide 413 may advantageously perform light guide and contact positioning functions reducing parts count and simplifying the design of the RJ45 jack 400.

The RJ45 jack 400 includes a plurality of through-hole contact pins 415 (shown in FIG. 4C) to facilitate electrical connection to upper contacts 409, lower contacts 414, the first LED 405, and the second LED 410. In addition, the RJ45 jack 400 may include a metal shell 416 that provides shielding from electrical noise and electromagnetic interference (EMI).

FIG. 4B is another cross-section drawing of the RJ45 jack 400 showing the first LED 405, first PCB 406, the first light guide 407, the second light guide 408 and upper contacts 409. As shown, the first light guide 407 surrounds the first LED 406 and may contact the second light guide 408. The second light guide 408 may include grooves 420 that guide the upper contacts 409.

FIG. 4C is another cross-section drawing of the RJ45 jack 400 showing the first LED 405 and the second LED 410 mounted to the first PCB 406 and the second PCB 411, respectively. FIG. 4C also shows the contact pins 415.

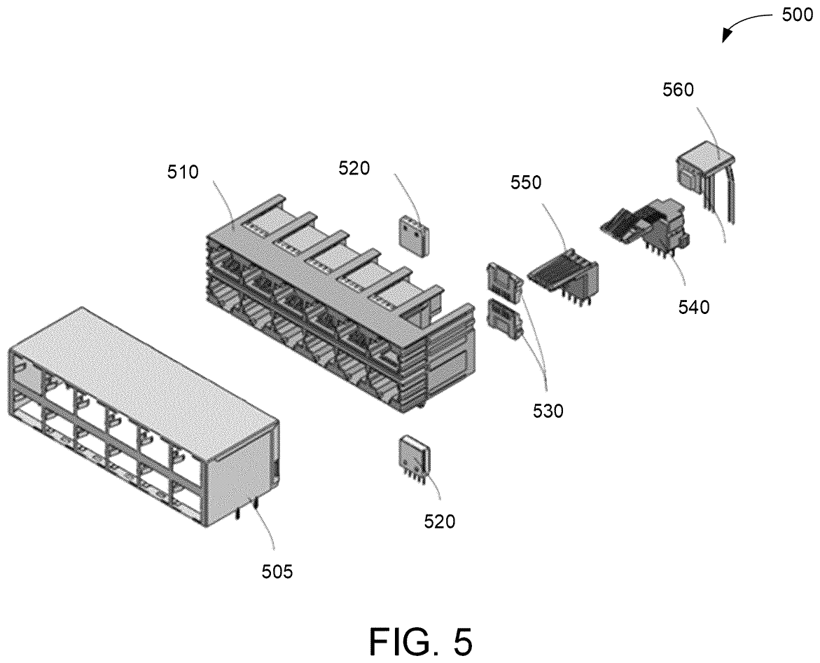

FIG. 5 is an exploded view of an RJ45 jack 500. The RJ45 jack 500 may be an example of the RJ45 jack 400 of FIGS. 4A-4C. The RJ45 jack 500 may include a shell 505 and a housing 510. The RJ45 jack 500 is an example of a 2×6 RJ45 jack. In other embodiments, the RJ45 jack 500 may be any other feasible arrangement (e.g., 1×8, 1×4, 1×2, etc.).

In some examples, some components of the RJ45 jack 500 may be duplicated to implement each individual receiving jack. For example, the RJ45 jack 500 may include any feasible number of first light guides 520, second light guides 530, upper contact assemblies 540, lower contact assemblies 550, and LED printed circuit assemblies (PCAs) 560. These commonly used parts may advantageously reduce the number of unique parts needed to assemble the RJ45 jack 500, thereby reducing costs.

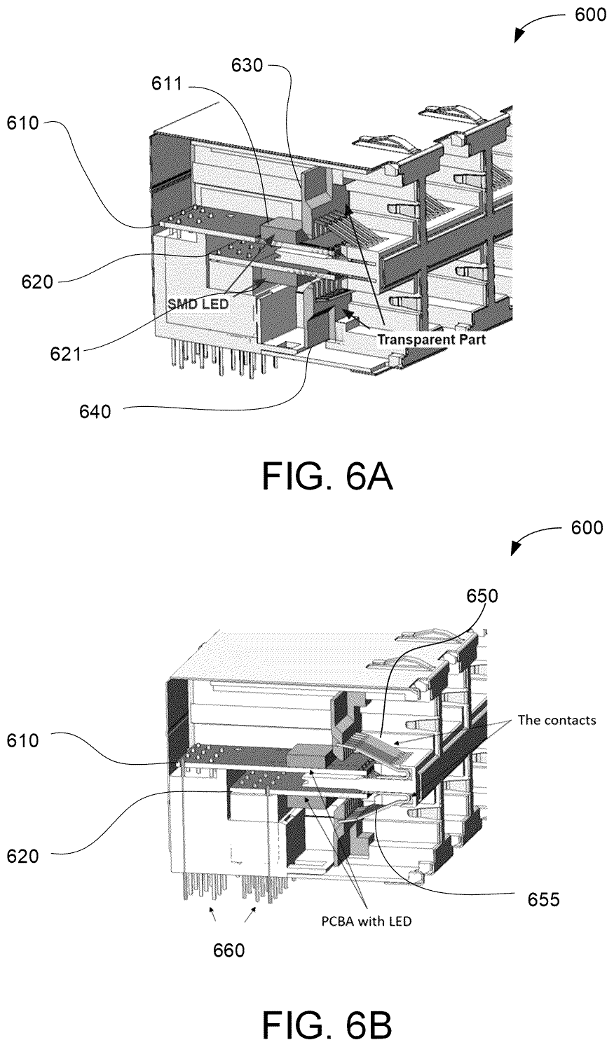

FIGS. 6A and 6B are cross-section drawings of another example two-row back lit RJ45 jack 600. FIG. 6A shows the RJ45 jack 600 that includes an upper LED PCA 610, a lower LED PCA 620, an upper light guide 630 and a lower light guide 640.

The upper LED PCA 610 includes an upper LED 611 (which may be surface mounted to the upper LED PCA 610). The upper LED 611 may be disposed adjacent or next to the upper light guide 630. The proximity of the upper LED 611 to the upper light guide 630 can enable the capture, diffusion, and or emission of light from the upper LED 611 into an upper region or cavity of the RJ45 jack 600.

The lower LED PCA 620 includes a lower LED 621 (which may be surface mounted to the lower LED PCA 620). The lower LED 621 may be disposed adjacent or next to the lower light guide 640. Thus, the lower light guide 640 can capture and diffuse light from the lower LED 621 into a lower RJ45 port. The proximity of the lower LED 621 to the lower light guide 640 can enable the capture and diffuse of light from the upper LED 621 into a lower region of the RJ45 jack 600. The upper LED 611 and the lower LED 621 may be multicolor LEDs. That is, each LED may emit a variety of colors, not just one or two colors.

FIG. 6B shows another cross-section of the RJ45 jack 600 that includes the upper LED PCA 610 and the lower LED PCA 620. Upper contacts 650 are coupled to the upper LED PCA 610 and lower contacts 655 are coupled to the lower LED PCA 620. Contact pins 660 are attached to the upper LED PCA 610 and the lower LED PCA 620. The contact pins 660 may provide electrical coupling to the upper contacts 650 and the lower contacts 655. In some examples, the contact pins 660 can also provide electrical coupling to the upper LED 611 and the lower LED 621 via respective PCBs. The upper light guide 630 and the lower light guide 640 may include one or more grooves to guide the upper contacts 650 and the lower contacts 655, respectively. In contrast to the RJ45 jack 400 of FIGS. 4A and 4B, the RJ45 jack 600 may usc fewer components advantageously reducing parts count and costs.

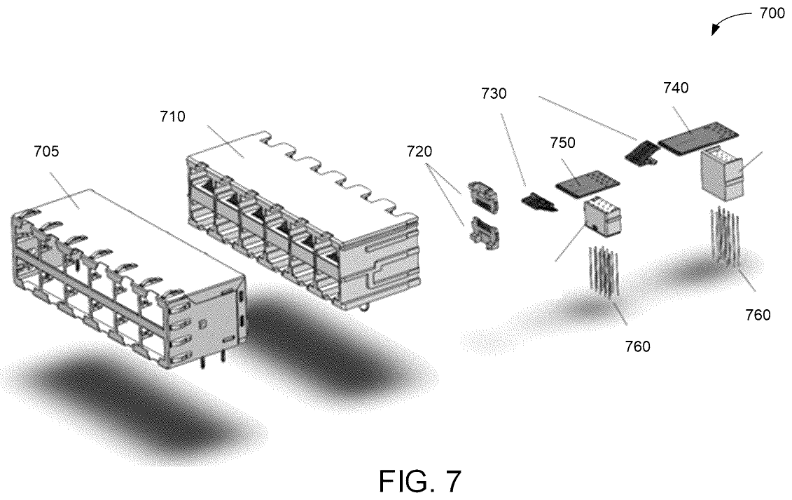

FIG. 7 is an exploded view of an RJ45 jack 700. The RJ45 jack 700 may be an example of the RJ45 jack 600 of FIGS. 6A and 6B. The RJ45 jack 700 may include a shell 705 and a housing 710. The RJ45 jack 700 is an example of a 2×6 RJ45 jack. In other embodiments, the RJ45 jack 700 may be any other feasible arrangement (e.g., 1×8, 1×4, 1×2, etc.).

In some examples, some components of the RJ45 jack 700 may be duplicated to implement each individual receiving jack. For example, the RJ45 jack 700 may include any feasible number of light guides 720, upper and lower contacts 730, upper LED PCAs 740, lower LED PCAs 750, and contact pins 760. The commonly used parts may advantageously reduce the number of unique parts needed to assemble the RJ45 jack 700, thereby reducing costs.

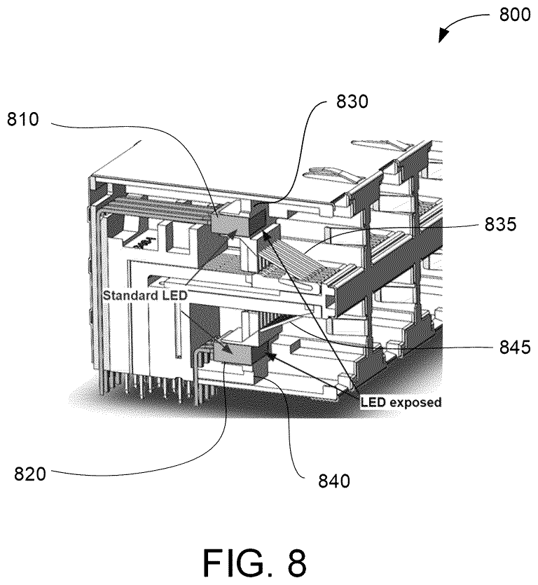

FIG. 8 is cross-section drawing of another example two-row back lit RJ45 jack 800. In contrast to the RJ45 jack 400 of FIGS. 4A-4C and the RJ45 jack 600 of FIGS. 6A and 6B, the RJ45 jack 800 does not rely on any light guide to illuminate the interior of the RJ45 jack 800. The RJ45 jack 800 includes an upper LED 810, a lower LED 820, an upper contact guide 830, and a lower contact guide 840. The upper contact guide 830 and the lower contact guide 840 may guide and position upper contacts 835 and lower contacts 845, respectively.

The upper LED 810 may be disposed through an opening in the upper contact guide 830 enabling light to be emitted into the interior (e.g., cavity) of an upper RJ45 port. In a similar manner, the lower LED 820 may be disposed through an opening in the lower contact guide 840 enabling light to be emitted into the interior of a lower RJ45 jack 800. Thus, the upper LED 810 and the lower LED 820 may emit light directly into the cavity of the RJ45.

In some examples, some components of the RJ45 jack 800 may be duplicated to implement each individual receiving jack. For example, the RJ45 jack 800 may include any feasible number of upper LEDs 810, lower LEDs 820, upper contact guides 830, and lower contact guides 840. The commonly used parts may advantageously reduce the number of unique parts needed to assemble the RJ45 jack 800, thereby reducing costs.

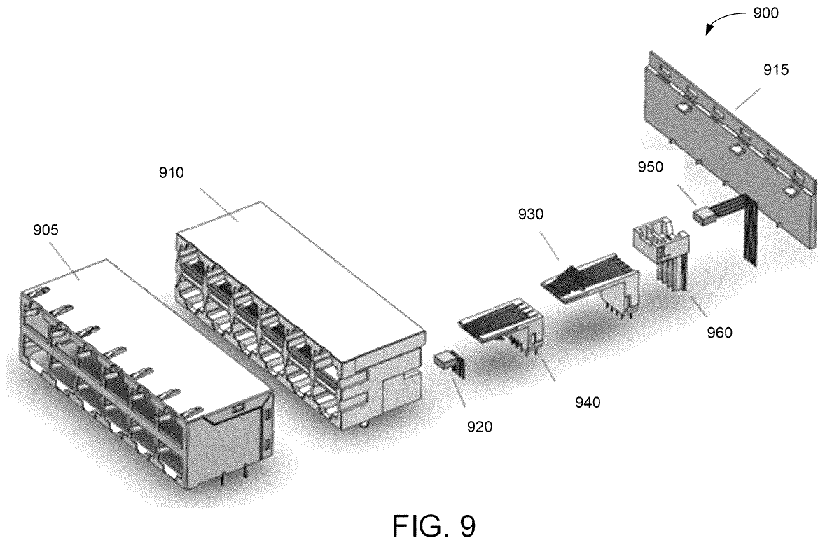

FIG. 9 is an exploded view of an RJ45 jack 900. The RJ45 jack 900 may be an example of the RJ45 jack 800 of FIG. 8. The RJ45 jack 900 may include a shell 905, a housing 910, and a back cover 915. The RJ45 jack 900 is another example of a 2×6 RJ45 jack. In other embodiments, the RJ45 jack 900 may be any other feasible arrangement (e.g., 1×8, 1×4, 1×2, etc.).

In some examples, some components of the RJ45 jack 900 may be duplicated to implement each individual receiving jack. For example, the RJ45 jack 900 may include any feasible number of lower LEDs 920, upper contact assemblies 930, lower contact assemblies 940, upper LEDs 950 and LED support blocks 960. The commonly used parts may advantageously reduce the number of unique parts needed to assemble the RJ45 jack 900, thereby reducing costs.

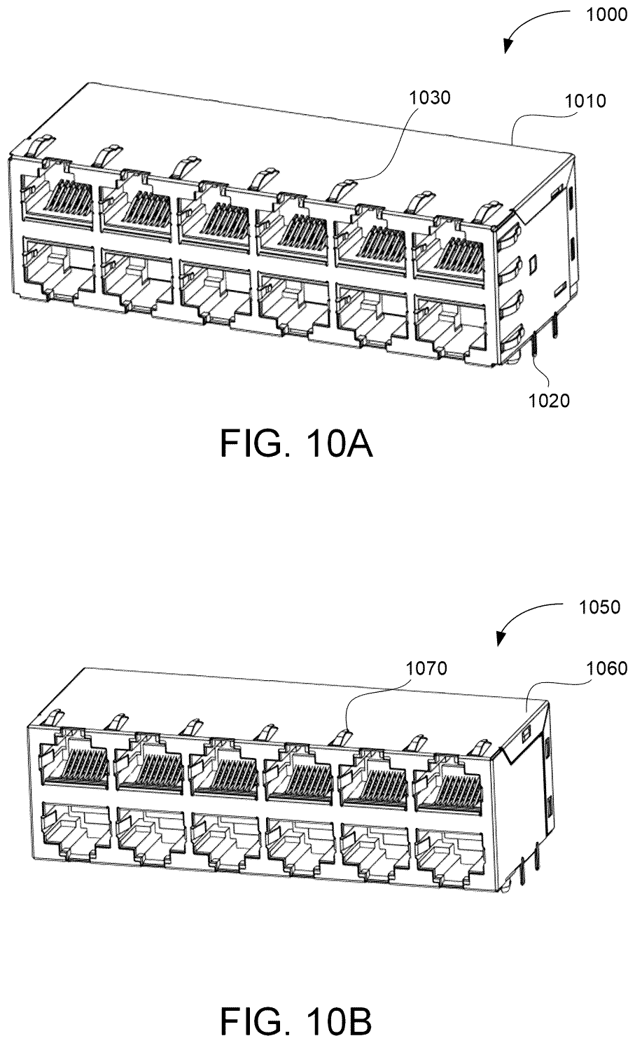

FIGS. 10A-10B are illustrations showing example shells for RJ45 jacks. As described with respect to the RJ45 jack 300 of FIG. 3A, the outer shells of the RJ45 jacks may be used for shielding and for reducing EMI emissions. FIG. 10A shows an RJ45 jack 1000 with a shell 1010. The shell 1010 may be aluminum, steel, copper alloy, or any other feasible conductive material. The shell 1010 may include one or more pins 1020 that may be attached or coupled to a circuit ground, for example through a PCB (not shown). The shell 1010 may include flexible conductive fingers 1030 on upper and side surfaces of the RJ45 jack 1000. The fingers 1030 may contact a chassis or housing that may also be connected to a circuit ground. Thus, the fingers 1030 may enable a relatively continuous electrical shield to surround circuitry associated with an ethernet switch. FIG. 10B shows an RJ45 jack 1050 with a shell 1060. In contrast to the RJ45 jack 1000, the shell 1060 only includes conductive fingers 1070 on an upper surface of the RJ45 jack 1050. In some applications, the additional fingers of the RJ45 jack 1000 may be unnecessary or may bind or interfere with other components. Thus, the conductive fingers of the side surfaces of the RJ45 jack 1050 may be omitted.

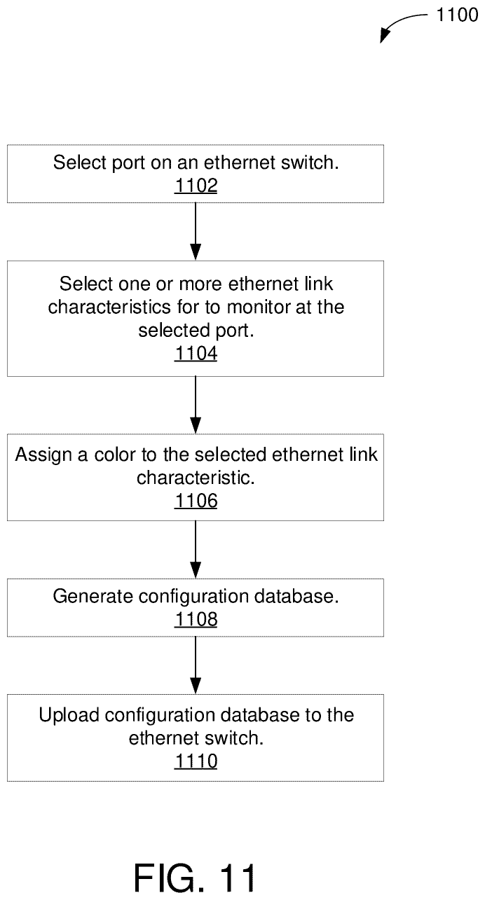

FIG. 11 is a flowchart showing an example method 1100 for generating color assignment information (e.g., a configuration database) for back lit RJ45 jacks of an ethernet switch. Although described herein in terms of an ethernet switch, the method 1100 may be applied to any back lit RJ45 jack. Some examples may perform the operations described herein with additional operations, fewer operations, operations in a different order, operations in parallel, and some operations differently. The method 1100 is described below with respect to network system 100 of FIG. 1, however, the method 1100 may be performed by any other suitable system or device.

The method 1100 begins in block 1102 as a user selects a port of an ethernet switch. The term port as used herein refers to a particular RJ45 jack typically receives an ethernet cable terminated with an RJ45 plug. In some cases, an RJ45 jack may include one or more ports, as illustrated herein in FIGS. 3A-3E. Selection of the port may be through any feasible device or interface. For example, a user interface, including a graphical user interface, may be displayed through a mobile device (mobile phone, tablet computer, laptop, etc.) or through any feasible web browser. In some variations, the user may be presented different selectable ports through a drop-down menu presented on a graphical user interface. Selection of the port, through the user interface, may be transmitted through the network 140 to the console 110.

Next in block 1104, an ethernet link characteristic is selected for monitoring at the selected port. The ethernet link characteristic can be any feasible link information or device characteristic. Example link characteristics may include data link speed, ethernet throughput, packet type, and the like described with respect to FIG. 2. Example device characteristics may include a temperature of the device, a connected device type (switch, access point, end device), and the like. Similar to block 1102, the selection may be made through any feasible device and transmitted to the console 110. In some variations, the user may be presented different selectable communication characteristics and/or device characteristics through a drop-down menu presented on a graphical user interface.

Next, in block 1106, a color is assigned to the selected ethernet link characteristic. For example, through a user interface a user may select a color that may be generated or produced by the selected port (e.g., an LED associated with the selected port). In some variations, the user may be presented different available colors through a drop-down menu presented on a graphical user interface.

Next in block 1108, the console 110 may generate a configuration database. The configuration database associates particular ethernet link characteristics with a particular port on a particular ethernet switch. Furthermore, the configuration database may associate particular colors with the selected ethernet link characteristics. In this manner the configuration database may include color assignment information associating colors with ethernet communication metrics, communication characteristics, or other device characteristics.

Next, in block 1110, the configuration database is uploaded to the ethernet switch. In some examples, the console 110 may transmit the configuration database to any selected ethernet switch, including any of the enhanced ethernet switches 120-122 of FIG. 1. For example, a processor included in the ethernet switch may receive the configuration database. The processor may then use the configuration database to determine how and when to illuminate any port of a back lit RJ45.

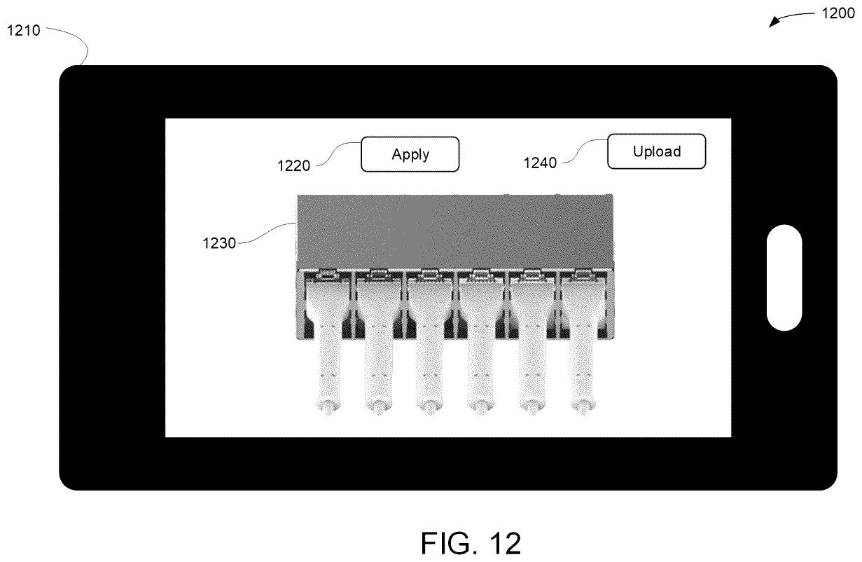

FIG. 12 shows an example graphical user interface 1200. The graphical user interface may be executed on (hosted by) a mobile phone, a tablet computer, a laptop computer, a web browser, or any other feasible device. In the example of FIG. 12, the graphical user interface is hosted on a mobile phone 1210. After determining the association between port, monitoring characteristic, and color, the user may click on (press) the apply button 1220. In response to detecting activity associated with the apply button 1220, a simulation of the back lit RJ45 jacks 1230 is displayed for the user. The simulation allows the user to evaluate the configuration. If the user approves the configuration, the user can click on (press) the upload button 1240 to upload the configuration to the selected ethernet switch. (Although described as buttons, the apply button 1220 and the upload button 1240 are graphical images meant to receive a user interaction (mouse click, touch, or the like).)

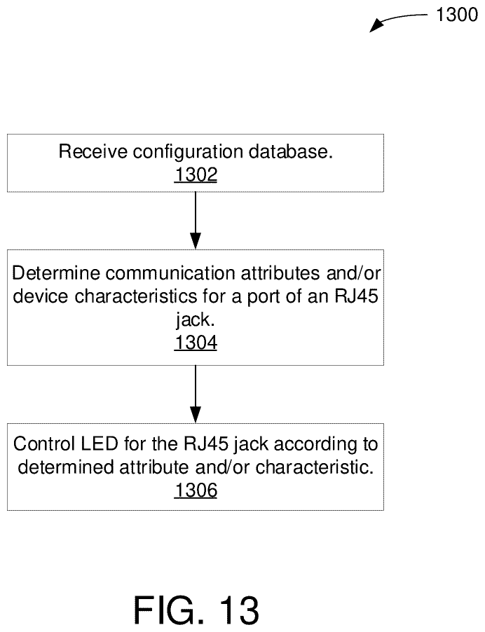

FIG. 13 is a flowchart showing an example method 1300 for controlling back lit RJ45 jacks. The method 1300 is described with respect to an ethernet switch such as any of the ethernet switches 120-122 of FIG. 1. However, the method 1300 may be used to control any RJ45 jack described herein. The method 1300 begins in block 1302 as the ethernet switch receives a configuration database. In some examples, a controller or processor within the ethernet switch may receive the configuration database. In some other examples, the configuration database may be a default database containing default associations between colors and ethernet link information. The default database may be loaded or programed at the factory or as part of an initial configuration step. As described above with respect to FIG. 11, the configuration database may associate particular ports with particular communication attributes or device characteristics with particular colors. In some examples, the configuration database is stored in a memory.

Next, in block 1304, the ethernet switch determines communication attributes and/or device characteristics associated with a port of an RJ45 jack. In some examples, a processor of the ethernet switch, in conjunction with hardware, software, and/or firmware, can monitor data packets or other feasible signals associated with any particular port. In some cases, the communication attributes and device characteristics that are monitored may be based on the configuration database.

Next, in block 1306, the ethernet switch and control an LED for a port based on the determined communication attributes and/or device characteristics. For example, a processor of the ethernet switch may cause any LED of any RJ45 port to activate in conjunction with the configuration database. The configuration database may determine the color of any LED.

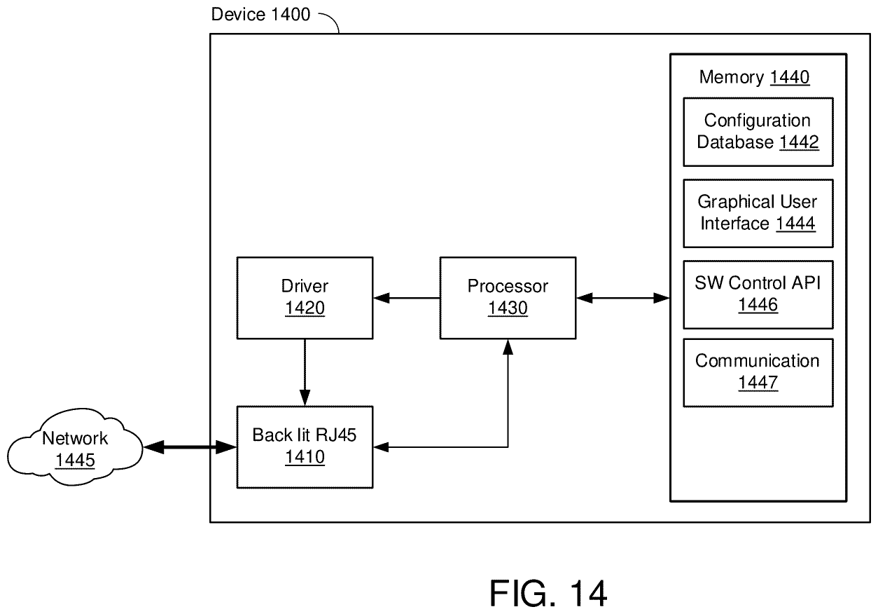

FIG. 14 shows a block diagram of a device 1400 that may be one example of the console 110 or switch 120-122 of FIG. 1. The device 1400 may include at least one back lit RJ45 jack 1410, a driver 1420, a processor 1430, and a memory 1440.

The back lit RJ45 jack 1410, which is coupled to the driver 1420 and the processor 1430, may be used to connect any feasible electrical equipment and/or network, such as network 1445, as shown. The back lit RJ45 jack 1410 may be an example of any of the RJ45 jacks described herein. Thus, the back lit RJ45 jack may include one or more LEDs that may be controlled, directly or indirectly, by the processor 1430 and/or the driver 1420.

The driver 1420 is coupled to the processor 1430 and the back lit RJ45 jack 1410. In some implementations, the driver 1420 can simply control colors of the back lit RJ45 jack 1410. For example, the driver 1420 may provide differing and/or variable voltages to LEDs within the back lit RJ45 to determine the colors generated by the LEDs. In some other examples, the driver 1420 can provide pulse-width modulated (PWM) signals to control the LEDs within the back lit RJ45 jack. In still other examples, the driver 1420 can provide any feasible signal (current, voltage, etc.) to control the LEDs.

The processor 1430, which is coupled to the memory 1440, may be any one or more suitable processors capable of executing scripts or instructions of one or more software programs stored in the device 1400 (such as within memory 1440).

The memory 1440 may include a configuration database 1442. The configuration 1442 database associates particular communication and/or device characteristics with a particular back lit RJ45 jack, such as the back lit RJ45 jack 1410. Furthermore, the configuration database 1442 may associate particular colors with a selected communication and/or device characteristics. In some examples, the configuration database 1442 may be received through the network 1445.

The memory 1440 may also include a non-transitory computer-readable storage medium (e.g., one or more nonvolatile memory elements, such as EPROM, EEPROM, Flash memory, a hard drive, etc.) that may store the following software modules: a graphical user interface software module 1444, a software control application programming interface (API) 1446, and a communication software module 1447.

Execution of the graphical user interface software module 1444 may provide, display, or render a graphical interface with which a user may program, select, or simulate LED (illumination) functions associated with the back lit RJ45 jack 1410. Execution of the graphical user interface software module 1444 may cause the processor 1430 to perform any feasible graphical interface functions, including functions described herein, especially with respect to FIG. 12. For example, execution of the graphical user interface software module 1444 may enable a user to select one or more ethernet link characteristics and assign any feasible color of light to be emitted upon detection of the selected ethernet link characteristic. In some examples, execution of the graphical user interface software module 1444 may cause the processor 1430 to generate, write, or update the configuration database 1442.

Execution of the software control API 1446 may provide a programming interface that, when accessed, causes the processor 1430 to control one or more LEDs within the back lit RJ45 1410. For example, the processor 1430 may execute the software control API 1446 to light one or more LEDs within the back lit RJ45 1410 in accordance with the configuration database 1442.

The processor 1430 may execute the communication software module 1447 to communicate with any other feasible devices. For example, execution of the communication software module 1447 may enable the device 1400 to communicate via the driver 1420 and the back lit RF45 jack 1410. In some implementations, the driver 1420 may simply control LED colors. In some embodiments, execution of the communication software module 1447 may enable the device 1400 to communicate with network switches, servers, other computers, or any other feasible device. In some other embodiments, execution of the communication software module 1447 may implement encryption and/or decryption procedures.

In some variations, the functionality of any or all of the items within the memory 1440 may be implemented as a host process. Thus, execution of the host process may provide the functionality of the configuration database 1442, the graphical user interface software module 1444, the software control API 1446, and the communication software module 1447 included in the memory 1440.

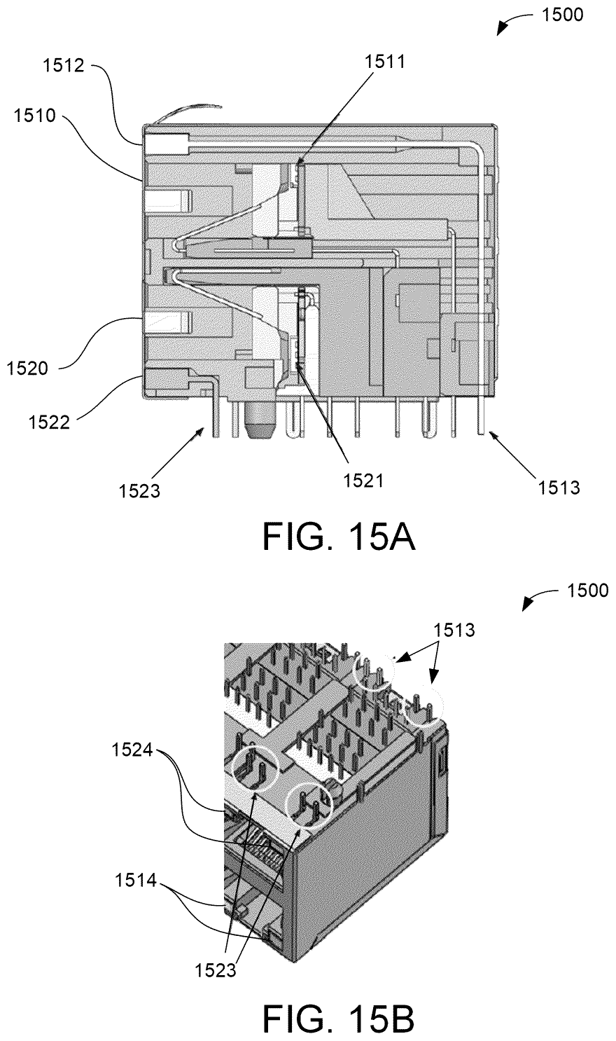

FIG. 15A is a cross-section drawing of another example two-row back lit RJ45 jack 1500. Although two vertical RJ45 ports are shown in the RJ45 jack 1500, any feasible number of RJ45 ports may be included in a horizontal direction. Similar to the RJ45 jacks of FIGS. 4-9 described herein, the RJ45 jack 1500 may include a multi-color LED that is arranged to disperse or diffuse light into the connector cavity. The color of light dispersed may be user selectable. Thus, the user may assign different colors of light to different ethernet link characteristics associated with any RJ45 port.

In addition to the cavity LED, optional LEDs may be disposed on either side of the opening of the RJ45 jack. Thus, two LEDs may be disposed on opposing sides of the opening. In some examples, the two LEDs may operate in a conventional manner to indicate ethernet link activity, link speed, or the like.

The RJ45 jack 1500 may include an upper RJ45 port 1510 and a lower RJ45 port 1520. The upper RJ45 port 1510 may include a multi-color LED 1511 arranged to disperse light into the cavity of the upper RJ45 port 1510. An LED 1512 may be disposed toward one side of the upper RJ45 port 1510. In some examples, the upper RJ45 port 1510 may include two LEDs disposed on either side, although only one LED 1512 is shown here. As shown, a surface of the LED 1512 may be exposed to an outer surface of the upper RJ45 port 1510, in contrast to the LED 1511 which has no surfaces exposed to an outer surface of the upper RJ45 port 1510. The LED 1512 may include conductive leads 1513 exposed to an outer surface of the RJ45 jack 1500 to enable electrical current to be provided to the LED 1512.

In a similar manner, the lower RJ45 port 1520 may include a multi-color LED 1521 arranged to disperse light into the cavity of the lower RJ45 port 1520. The lower RJ45 port 1520 may include two LEDs disposed on either side, although only one LED 1522 is shown here. The LED 1522 may have at least one surface exposed to an outer surface of the lower RJ45 port 1520. The LED 1522 may include conductive leads 1523.

FIG. 15B shows an underside view of the RJ45 jack 1500. As shown, conductive leads 1513 may be coupled to upper LEDs of the RJ45 jack 1500. In a similar manner, conductive leads 1523 may be coupled to lower LEDs of the RJ45 jack 1500. For reference, FIG. 15B shows two upper LEDs 1514 and two lower LEDs 1524. The upper LEDs 1514 may include the LED 1512 of FIG. 15A. The lower LEDs 1524 may include the LED 1522 of FIG. 15A.

In some examples, the RJ45 jack 1500 may advantageously have a relatively low cost of both goods (bill of materials), and assembly. Furthermore, the two LEDs on each side of the connectors may operate in a conventional manner showing status of link activity, speed, power-over-ethernet, or the like. Thus, the meaning of the two LEDs may be easily understood.

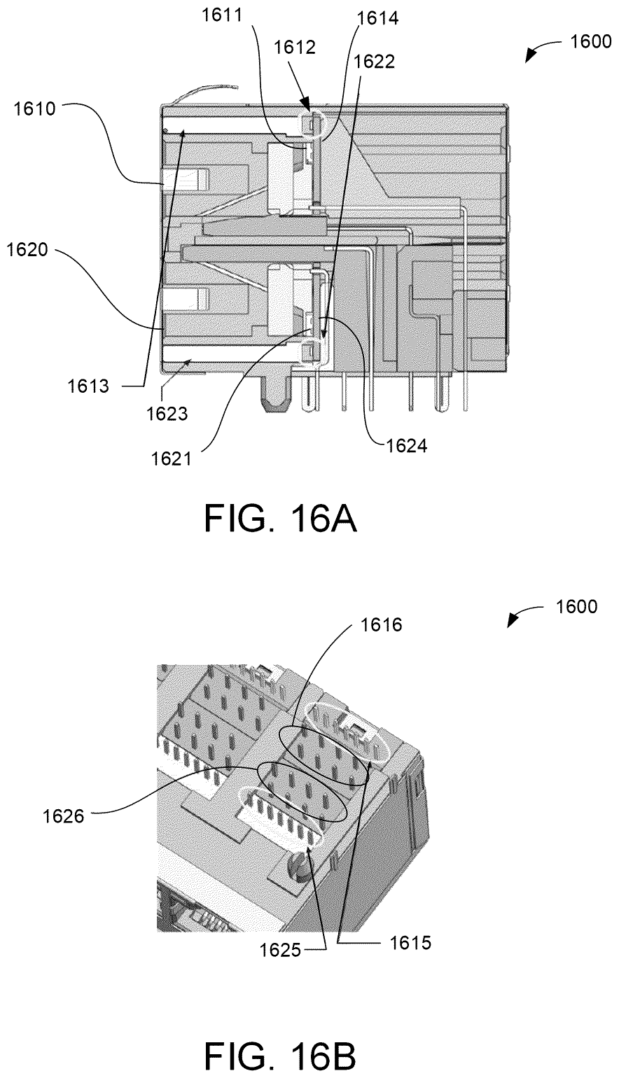

FIG. 16A a cross-section drawing of another example two-row back lit RJ45 jack 1600. Although two vertical RJ45 ports are shown in the RJ45 jack 1600, any feasible number of RJ45 ports may be included in a horizontal direction. Similar to the RJ45 jack for FIG. 15A and FIG. 15B, the RJ45 jack 1600 may include a multi-color LED that is arranged to disperse or diffuse light into the connector cavity. The color of light dispersed may be user selectable. Thus, the user may assign different colors of light to different ethernet link characteristics associated with any RJ45 port.

The RJ45 jack 1600 may include an upper RJ45 port 1610 and a lower RJ45 port 1620. The upper RJ45 port 1610 may include a multi-color LED 1611 arranged to disperse light into the cavity of the upper RJ45 port 1610. An LED 1612 may be disposed toward one side of the upper RJ45 port 1610. In some examples, the upper RJ45 port 1610 may include two LEDs disposed on either side, although only one LED 1612 is shown here. A light guide 1613 may be disposed adjacent or next to the LED 1612. The light guide 1613 can convey or transmit light from the LED 1612 to an outer surface of the RJ45 jack 1600.

The lower RJ45 port 1620 may include a multi-color LED 1621 and an LED 1622 disposed toward one side of the lower RJ45 port 1620. A light guide 1623 may convey or transmit light from the LED 1622 to an outer surface of the RJ45 jack 1600.

The LED 1611 and the LED 1612 may be mounted on a PCB 1614. In a similar manner, the LED 1621 and the LED 1622 may be mounted on a PCB 1624. Since the LEDs for each RJ45 port are mounted on a shared/common PCB, the connections for the LED may be disposed next to each other as shown in FIG. 16B.

FIG. 16B shows an underside view of the RJ45 jack 1600. Conductive leads 1615 may be coupled to LEDs associated with the upper RJ45 port 1610 and conductive leads 1625 may be coupled to LEDs associated with the lower RJ45 port 1620. Notably, the conductive leads for LEDs of each RJ45 port are disposed adjacent to each other. The arrangement of conductive leads may enable easier signal routing to and from the ethernet signaling pins 1616 and 1626. Easier signal routing may be advantageous particularly for high-speed differential signals, such as ethernet signals. In addition, the number of pins that may be required may be reduced, compared to other implementations. Fewer pins can reduce costs and simplify PCB design.

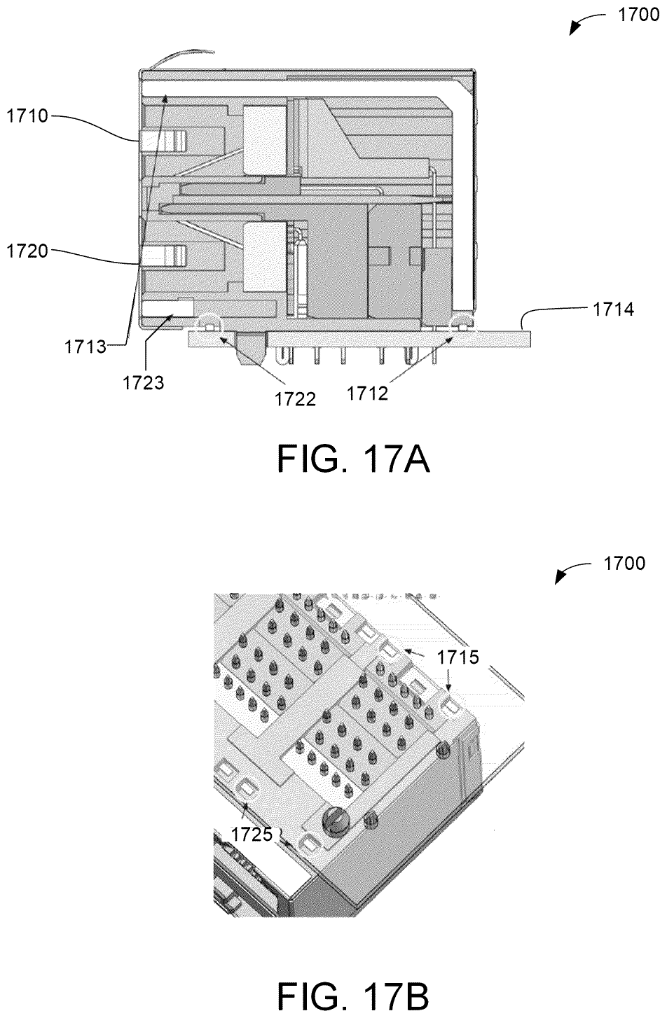

FIG. 17A a cross-section drawing of another example two-row back lit RJ45 jack 1700. Although two vertical RJ45 ports are shown in the RJ45 jack 1700, any feasible number of RJ45 ports may be included in a horizontal direction. Similar to the RJ45 jack for FIG. 15A and FIG. 15B, the RJ45 jack 1700 may include a multi-color LED (not shown) that is arranged to disperse or diffuse light into the connector cavity. The color of light dispersed may be user selectable. Thus, the user may assign different colors of light to different ethernet link characteristics associated with any RJ45 port.

The RJ45 jack 1700 may include an upper RJ45 port 1710 and a lower RJ45 port 1720. The upper RJ45 port 1710 may include LEDs disposed on either side of the upper RJ45 port 1710. The LEDs may be surface mounted. For example LED 1712 may be surface mounted to a PCB 1714. In some examples, the upper RJ45 port 1710 may include two LEDs disposed on either side, although only one LED 1712 is shown here. A light guide 1713 may be disposed adjacent or next to the LED 1712. The light guide 1713 can convey or transmit light from the LED 1712 to an outer surface of the RJ45 jack 1700.

The lower RJ45 port 1720 may include an LED 1722 disposed toward one side of the lower RJ45 port 1720. A light guide 1723 may convey or transmit light from the LED 1722 to an outer surface of the RJ45 jack 1700.

FIG. 17B shows an underside view of the RJ45 jack 1700. In particular, FIG. 17B shows surface mount LEDs 1715 for the upper RJ45 port 1710 and surface mount LEDs 1725 for the lower RJ45 port 1720. In some aspects, the surface mount LEDs used in RJ45 jack 1700 may advantageously provide more possible choices for LED selection compared to conventional, leaded LEDs (for example, as used in RJ45 Jack 1500.

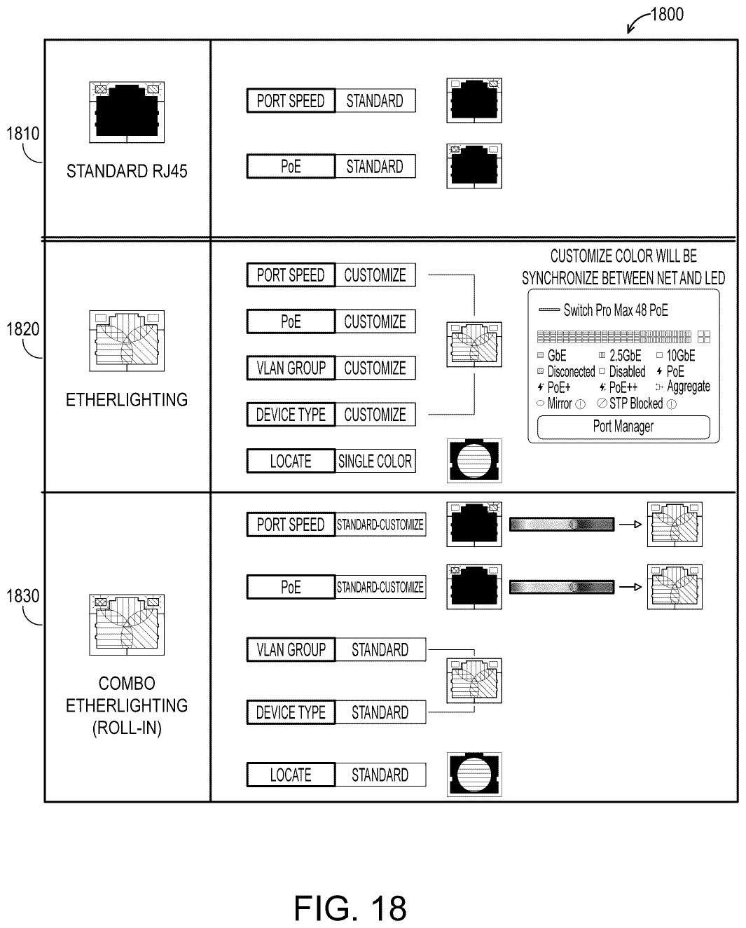

FIG. 18 shows an example user interface 1800 that may be used to configure or program LED behaviors for any of the LEDs described herein. A first section 1810 of the user interface 1800 may be used to program LED behavior (e.g., activity) for “standard RJ45” ports. As used herein a standard RJ45 port may refer to an RJ45 port that includes two LEDs, one LED to either side of the RJ45 port (that is, two LEDS, one LED to either side of an opening of the RJ45 port that receives an RJ45 connector). In some examples, the user interface 1800 may allow a user to select a particular LED and associate a particular behavior with that LED. For example, any one of the LEDs may be designated to indicate port speed, port activity, power-over-ethernet behavior or the like.

A second section 1820 of the user interface 1800 may be used to program LED behavior for LEDs associated with an “etherlight” port. As used herein, an etherlight port may refer to any RJ45 port with a multi-color LED configured or arranged to disperse light within a cavity of the RJ45 port.

In some examples, the user interface 1800 may provide or enumerate different ethernet activities, characteristics, or behaviors and allow the user to associate a particular color with that activity. For example, the user may associate a different color with port speed, power-over-ethernet, virtual local area network (VLAN), or device type. In some examples, the user may select a color and/or blinking pattern or behavior that may be used to locate (by blinking or otherwise operating a back light LED) any one particular RJ45 port. The ethernet activities, characteristics, and behaviors described herein are meant to be illustrative and not limiting. For example, any other feasible ethernet characteristic may be associated with any feasible color.

A third section 1830 of the user interface 1800 may be used to program LED behavior for LEDs associated with a “combo” ethernet port. As used herein, a combo ethernet port may refer to any RJ45 that includes both conventional LEDs (such as the LEDs associated with the first section 1810) and multi-color LEDs (such as the LEDs associated with the second section 1820). For example, the user interface 1800 may enable the user to control the color and operation of LEDs disposed to either side of the RJ45 port as well as the color and operation of a multi-color LED arranged to illuminate an internal cavity of the RJ45 port.

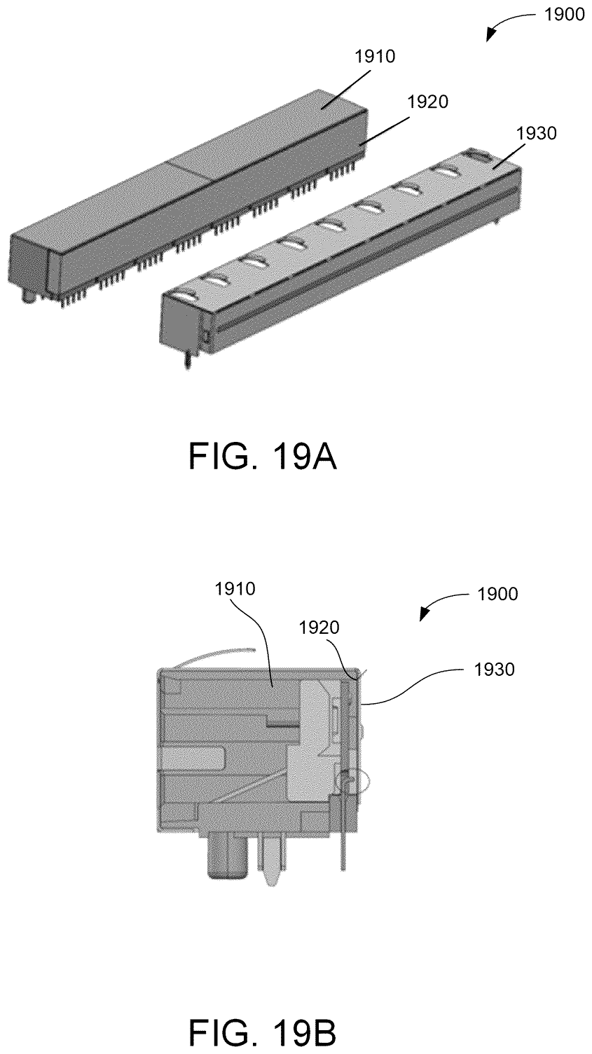

FIG. 19A is another exploded view of an RJ45 jack 1900. The RJ45 jack 1900 may include a housing 1910, an insulator 1920, and a shell 1930. Although illustrated as single row RJ45 connector, in other examples, the RJ45 jack 1900 may include any number of rows.

The housing 1910 may include ethernet signaling contacts and any of the LEDs, light guides, and/or PCBs described herein. The shell 1930 may be a formed or made out of a conductive material, such as metal, tin, or the like. The shell 1930 may provide shielding from electrical noise and electromagnetic interference (EMI). The insulator 1920 may be disposed between the housing 1910 and the shell 1930. The insulator 1920 may reduce or prevent the occurrence of any electrostatic discharge (ESD) events. In some examples, the insulator 1920 may be mylar. In some other examples, the insulator 1920 may be any material with insulating (non-electrically conductive) properties.

FIG. 19B shows a cross-section view of the RJ45 jack 1900. As shown, when the RJ45 jack 1900 is assembled, the insulator 1920 is disposed between the housing 1910 and the shell 1930.

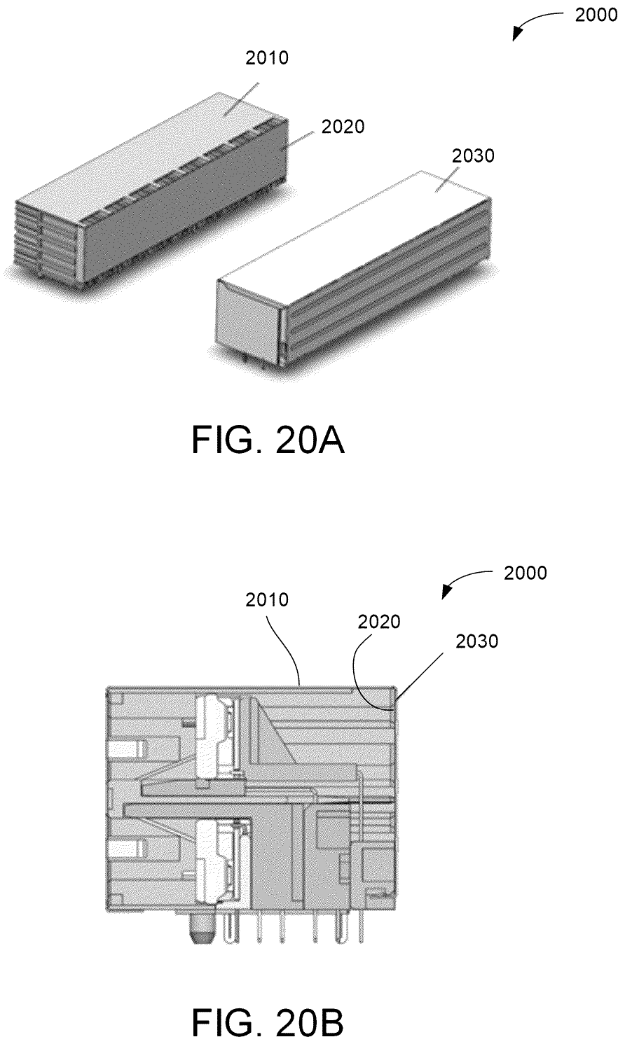

FIG. 20A is another exploded view of an RJ45 jack 2000. In contrast to the RJ45 jack of FIGS. 19A and 19B, the RJ45 jack 2000 is a two-row RJ jack, although in other examples, the RJ45 jack may include any feasible number of rows. The RJ45 jack 2000 may include a housing 2010, an insulator 2020, and a shell 2030. The housing 2010 may include ethernet signaling contacts and any of the LEDs, light guides, and/or PCBs described herein. The shell 2030 may be a formed or made out of a conductive material, such as metal, tin, or the like. The shell 2030 may provide shielding from electrical noise and electromagnetic interference (EMI). The insulator 2020 may be disposed between the housing 2010 and the shell 2030. The insulator 2020 may reduce or prevent the occurrence of any electrostatic discharge (ESD) events. In some examples, the insulator 2020 may be mylar. In some other examples, the insulator 2020 may be any material with insulating (non-electrically conductive) properties.

FIG. 20B shows a cross-section view of the RJ45 jack 2000. As shown, when the RJ45 jack 2000 is assembled, the insulator 2020 is disposed between the housing 2010 and the shell 2030.

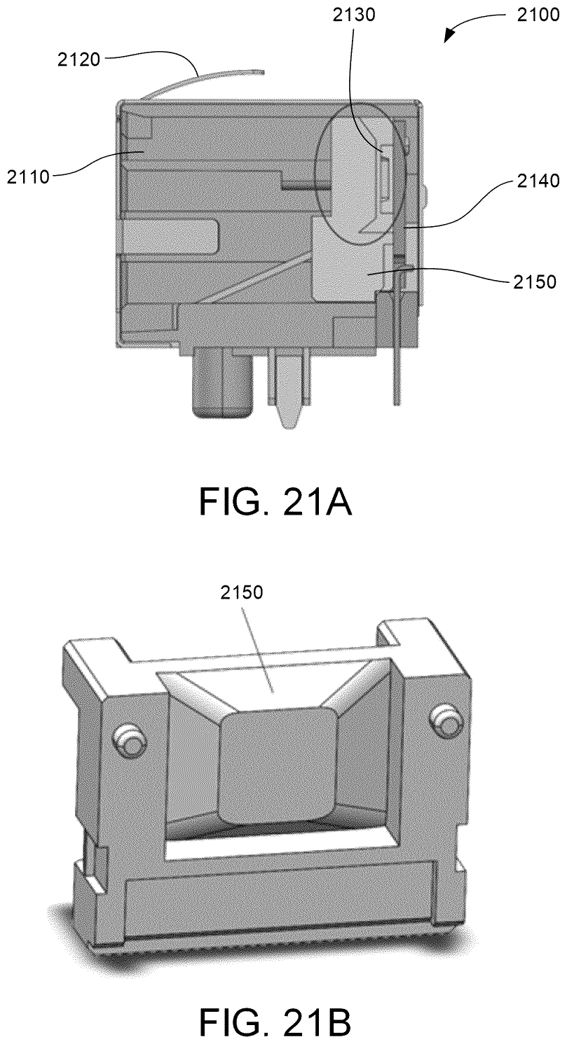

FIG. 21A shows a cross section of an RJ45 jack 2100. The RJ45 jack 2100 may include a housing 2110, a shell 2120, a multi-color LED 2130, a PCB 2140, and a light guide 2150. The housing 2110 may include ethernet signaling contacts and a cavity to receive an RJ45 connector. The multi-color LED 2130 may be mounted or affixed to the PCB 2140. Additionally, the multi-color LED 2130 may be arranged to emit light into the cavity of the RJ45 jack 2100.

The light guide 2150 may be disposed between the multi-color LED 2130 and the cavity of the RJ45 jack 2100. The light guide 2150 may diffuse and/or disperse light from the multi-color LED 2130. In some examples, the light guide 2150 can enhance illumination from the multi-color LED 2130 and increase optical uniformity. As shown, the light guide 2150 may be disposed between the multi-color LED 2130 and a cavity of the RJ45 jack 2100.

FIG. 21B shows a view of the light guide 2150. In some examples, FIG. 21B may show a side or surface of the light guide 2150 that may be adjacent to or contact the multi-color LED 2130.

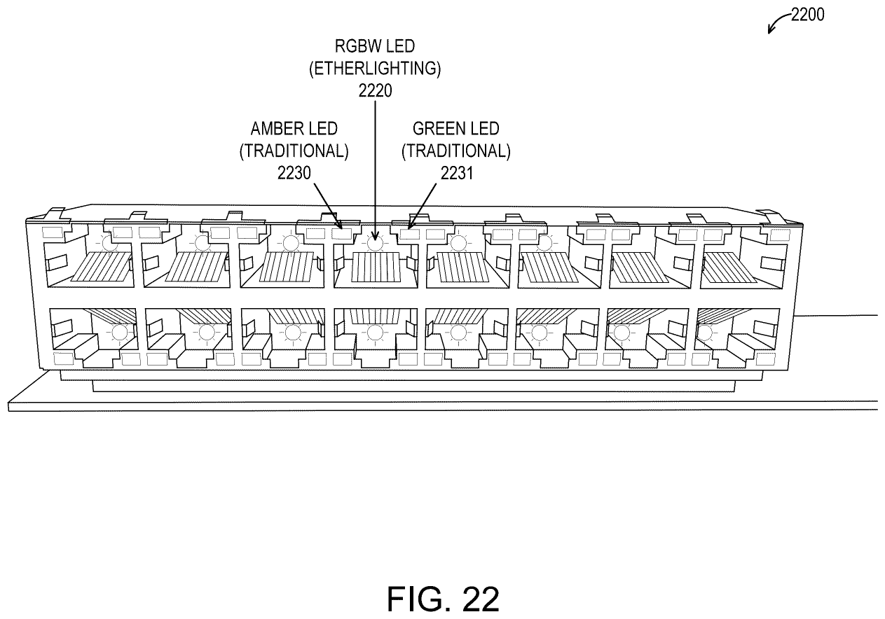

FIG. 22 shows an example implementation of an RJ45 jack 2200. Although the RJ45 jack 2200 includes sixteen discrete jacks, other implementations can include any number of discrete jacks. As shown, the RJ45 jack 2200 can include traditional (conventional) LEDs. For example, each RJ45 jack can include a first LED 2230 and a second LED 2231. The first LED 2230 and the second LED 2231 can be any color, although amber and green are typical. The first and second LEDs 2230 and 2231 can indicate activity, status, or the like. In addition, the RJ45 jack 2200 can include an LED 2220 that provides a back light to the cavity of each discrete jack. The back light LED 2220 can be any feasible multi-color LED. The color of the back light LED 2220 can reflect operations or status of the associated RJ45 jack, as described herein.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected,” “attached” or “coupled” to another feature or element, it can be directly connected, attached, or coupled to the other feature or element or intervening features or elements may be present. In contrast, when a feature or element is referred to as being “directly connected,” “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components, or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method for indicating ethernet link information through RJ45 jacks of a device, the method comprising:
receiving a configuration database that assigns colors to different ethernet link characteristics;
determining, by the device, at least one ethernet link characteristic associated with at least one ethernet port of the device; and
back lighting the at least one ethernet port with a color, wherein the color is determined by the at least one ethernet link characteristic and the configuration database.

2. The method of claim 1, wherein the configuration database is provided by a controller separate from the device.

3. The method of claim 2, wherein the configuration database is provided to the controller by a user.

4. The method of claim 1, wherein the configuration database is provided by a controller collocated within the device.

5. The method of claim 4, wherein the configuration database is uploaded to the device by a user.

6. The method of claim 4, wherein the configuration database is a default color assignment stored within the device.

7. The method of claim 1, wherein the ethernet link characteristic is an amount of power provided by the ethernet port for power-over-ethernet (POE) equipment coupled to the at least one ethernet port.

8. The method of claim 7, wherein the color of the back light changes in response to changing amounts of power provided by the at least one ethernet port.

9. The method of claim 1, wherein the ethernet link characteristic is based, at least in part, by a type of device coupled to the at least one ethernet port.

10. The method of claim 9, wherein the type of device includes at least one of an ethernet switch, a wired access point, a wireless access point, a server, or an intermediate node.

11. The method of claim 1, wherein the ethernet link characteristic is based, at least in part, on a data throughput of the at least one ethernet port.

12. The method of claim 11, wherein the data throughput is at least one of a real-time data throughput or a data throughput over a predetermined period of time.

13. The method of claim 1, wherein the ethernet link characteristic is based, at least in part, by a virtual local area network (VLAN) packet type included in ethernet data passing through the at least one ethernet port.

14. The method of claim 1, wherein the color of the back light is further determined, at least in part, by at least one of cable quality or cable length of cable coupled to the at least one ethernet port.

15. The method of claim 1, wherein the color of the back light is further determined, at least in part, by a temperature of the at least one ethernet port.

16. The method of claim 1, wherein the ethernet link characteristic is based, at least in part, on a data link speed of the at least one ethernet port.

17. The method of claim 1, wherein back lighting the at least one ethernet port is based, at least in part, on receiving a command to locate the at least one ethernet port.

18. The method of claim 17, wherein the command causes a cavity of the at least one ethernet port to blink or pulsate.

19. A method for generating a configuration database for back lit RJ45 jacks of a device via a graphical user interface, the method comprising:
detecting, via a user interaction with a graphical user interface, a user selection of a first ethernet port from a plurality of ethernet ports of the device;
assigning, by the user, a first ethernet link characteristic to the first ethernet port;
assigning, by the user, a first color to the first ethernet link characteristic;
generating a configuration database based on the assignment of the first color to the first ethernet link characteristic; and
transmitting the configuration database to the device.

20. The method of claim 19, further comprising displaying a simulation of the device based at least in part on the configuration database.

21. The method of claim 19, further comprising displaying a simulation of the ethernet port based at least on the configuration database.

22. The method of claim 19, wherein the configuration database determines back light color of the first ethernet port of the device.

23. The method of claim 19, further comprising:
displaying, in response to the user selection of a first ethernet port, a plurality of ethernet link characteristics; and
selecting, by the user, the first ethernet link characteristic from the plurality of ethernet link characteristics.

24. The method of claim 23, wherein the plurality of ethernet link characteristics is displayed with a drop-down menu.

25. The method of claim 19, further comprising displaying an image of the device, wherein detecting the user selection of the first ethernet port is in response to displaying the image of the device.

26. The method of claim 25, wherein the image of the device includes at least part of the plurality of ethernet ports.

27. The method of claim 19, further comprising:
displaying a plurality of colors in response to assigning the first ethernet link characteristic to the first ethernet port; and
selecting the first color from the plurality of colors.

28. The method of claim 19, further comprising:
assigning, by the user, a second ethernet link characteristic to the first ethernet port;
assigning, by the user, a second color to the second ethernet link characteristic; and
generating a configuration database based on the assignment of the second color to the second ethernet link characteristic.

29. The method of claim 19, further comprising:
detecting, via a user interaction with a graphical user interface, a user selection of a second ethernet port from a plurality of ethernet ports of the device;
assigning, by the user, a third ethernet link characteristic to the second ethernet port;
assigning, by the user, a third color to the third ethernet link characteristic; and
generating a configuration database based on the assignment of the third color to the third ethernet link characteristic.

30.-53. (canceled)
